(19) United States
(12) Patent Application Publication
(10) Pub. No.: US 2017/0337748 A1
(43) Pub. Date: Nov. 23, 2017

(54) THREE-DIMENSIONAL DATA GENERATION DEVICE, THREE-DIMENSIONAL SHAPING DEVICE, AND NON-TRANSITORY COMPUTER READABLE MEDIUM

(71) Applicant: FUJI XEROX CO., LTD., Tokyo (JP)

(72) Inventor: Yoshifumi TAKEBE, Kanagawa (JP)

(73) Assignee: FUJI XEROX CO., LTD., Tokyo (JP)

(21) Appl. No.: 15/344,921

(22) Filed: Nov. 7, 2016

(30) Foreign Application Priority Data
May 20, 2016 (JP) 2016-101233

(51) Int. Cl. G06T 19/20; G06T 3/40; G06T 17/10

(52) U.S. Cl. CPC G06T 19/20; G06T 17/10; G06T 3/40; G06T 2219/2021

(57) ABSTRACT

A three-dimensional data generation device includes a deformation prediction section and a data correction section. The deformation prediction section predicts deformation of a shaped object after being shaped, from a shape prescribed by three-dimensional data, on the basis of a geometric feature of the shape prescribed by the three-dimensional data. The data correction section corrects the three-dimensional data so as to reduce the deformation of the shaped object after being shaped, from the shape prescribed by the three-dimensional data, on the basis of the predicting by the deformation prediction section.

### CROSS-REFERENCE TO RELATED APPLICATIONS

This application is based on and claims priority under 35 USC 119 from Japanese Patent Application No. 2016-101233 filed May 20, 2016.

### BACKGROUND

### Technical Field

The present invention relates to a three-dimensional data generation device, a three-dimensional shaping device, and a non-transitory computer readable medium.

### SUMMARY

According to an aspect of the present invention, there is provided a three-dimensional data generation device including: a deformation prediction section that predicts deformation of a shaped object after being shaped, from a shape prescribed by three-dimensional data, on a basis of a geometric feature of the shape prescribed by the three-dimensional data; and a data correction section that corrects the three-dimensional data so as to reduce the deformation of the shaped object after being shaped, from the shape prescribed by the three-dimensional data, on a basis of the predicting by the deformation prediction section.

### BRIEF DESCRIPTION OF THE DRAWINGS

Exemplary embodiments of the present invention will be described in detail based on the following figures, wherein:

FIG. 1 illustrates a three-dimensional shaping system according to an exemplary embodiment of the present invention;

FIG. 2 illustrates a three-dimensional shaping device of the three-dimensional shaping system illustrated in FIG. 1;

FIG. 3 is a block diagram illustrating a controller of the three-dimensional shaping device illustrated in FIG. 2;

FIG. 4 is a block diagram illustrating the functional configuration of a data generation device illustrated in FIG. 1;

FIG. 5 is a flowchart illustrating the course of data generation performed by the data generation device illustrated in FIG. 4;

FIG. 6A illustrates deformation of a shaped object after being shaped, from a shape prescribed by three-dimensional data, for a case where a common data generation system is used, illustrating the shape prescribed by the three-dimensional data;

FIG. 6B illustrates deformation of the shaped object after being shaped, from the shape prescribed by the three-dimensional data, for a case where a common data generation system is used, illustrating the shaped object after being shaped;

FIG. 7A illustrates an example of deformation of a shaped object after being shaped, from a shape prescribed by three-dimensional data, for a case where the three-dimensional shaping system illustrated in FIG. 1 is used, illustrating the shape prescribed by the three-dimensional data;

FIG. 7B illustrates an example of deformation of the shaped object after being shaped, from the shape prescribed by the three-dimensional data, for a case where the three-dimensional shaping system illustrated in FIG. 1 is used, illustrating a shape prescribed by corrected three-dimensional data;

FIG. 7C illustrates an example of deformation of the shaped object after being shaped, from the shape prescribed by the three-dimensional data, for a case where the three-dimensional shaping system illustrated in FIG. 1 is used, illustrating a shaped object shaped on the basis of the corrected three-dimensional data;

FIG. 8A illustrates another example of deformation of a shaped object after being shaped, from a shape prescribed by three-dimensional data, for a case where the three-dimensional shaping system illustrated in FIG. 1 is used, illustrating a shape prescribed by corrected three-dimensional data;

FIG. 8B illustrates another example of deformation of the shaped object after being shaped, from the shape prescribed by the three-dimensional data, for a case where the three-dimensional shaping system illustrated in FIG. 1 is used;

FIG. 9A illustrates an algorithm for calculating an acuteness degree of a ridge line, illustrating three-dimensional data including the ridge line, the acuteness degree of which is to be calculated;

FIG. 9B illustrates the algorithm for calculating the acuteness degree of the ridge line, indicating an expression that defines the acuteness degree of the ridge line;

FIG. 10A illustrates an algorithm for calculating an acuteness degree of a vertex, illustrating three-dimensional data including the vertex, the acuteness degree of which is to be calculated;

FIG. 10B illustrates the algorithm for calculating the acuteness degree of the vertex, indicating an expression that defines the acuteness degree of the vertex;

FIG. 11A illustrates an example of the result of calculating the acuteness degree of the ridge line, illustrating an example of a shape prescribed by three-dimensional data;

FIG. 11B illustrates an example of the result of calculating the acuteness degree of the ridge line, illustrating only some of the ridge lines of the shape illustrated in FIG. 11A, the acuteness degree of which is less than 0.3;

FIG. 12 illustrates an example of parameters stored in a parameter storage section;

FIG. 13 illustrates shaped objects for testing shaped to correct the parameters stored in the parameter storage section;

FIG. 14 is a flowchart illustrating a process for correcting the parameters stored in the parameter storage section;

FIG. 15A illustrates an algorithm for predicting deformation of a shaped object after being shaped at positions other than ridge lines and vertexes, illustrating a shape prescribed by three-dimensional data;

FIG. 15B illustrates the algorithm for predicting deformation of the shaped object after being shaped at positions other than the ridge lines and the vertexes, illustrating a shape prescribed by three-dimensional data corrected on the basis of the prediction results;

FIG. 16A illustrates a first example of a change in resolution of the three-dimensional data, illustrating a shape prescribed by three-dimensional data before the change;

FIG. 16B illustrates the first example of the change in resolution of the three-dimensional data, illustrating a shape prescribed by three-dimensional data after the change;

FIG. 17A illustrates a second example of a change in resolution of the three-dimensional data, illustrating a shape prescribed by three-dimensional data before the change;

FIG. 17B illustrates the second example of the change in resolution of the three-dimensional data, illustrating a shape prescribed by three-dimensional data after the change;

FIG. 18A illustrates a third example of a change in resolution of the three-dimensional data, illustrating a shape prescribed by three-dimensional data before the change;

FIG. 18B illustrates the third example of the change in resolution of the three-dimensional data, illustrating a shape prescribed by three-dimensional data after the change;

FIG. 18C illustrates the third example of the change in resolution of the three-dimensional data, illustrating a shape prescribed by three-dimensional data, the resolution of which has been further changed;

FIG. 19A illustrates a first algorithm for enhancing the resolution of three-dimensional data;

FIG. 19B illustrates a second algorithm for enhancing the resolution of three-dimensional data;

FIGS. 20A to 20D illustrate a first example of an algorithm for lowering the resolution of three-dimensional data;

FIGS. 21A to 21D illustrate a second example of an algorithm for lowering the resolution of three-dimensional data;

FIG. 22A illustrates remeshing of three-dimensional data, illustrating a shape prescribed by the three-dimensional data before being remeshed;

FIG. 22B illustrates remeshing of the three-dimensional data, illustrating a shape prescribed by the three-dimensional data after being remeshed;

FIGS. 23A to 23C illustrate an algorithm for changing three-dimensional data so as to have different resolutions in an X-axis direction, a Y-axis direction, and a Z-axis direction; and

FIG. 24 is a block diagram illustrating the functional configuration of a three-dimensional shaping device according to a second exemplary embodiment of the present invention.

### DETAILED DESCRIPTION

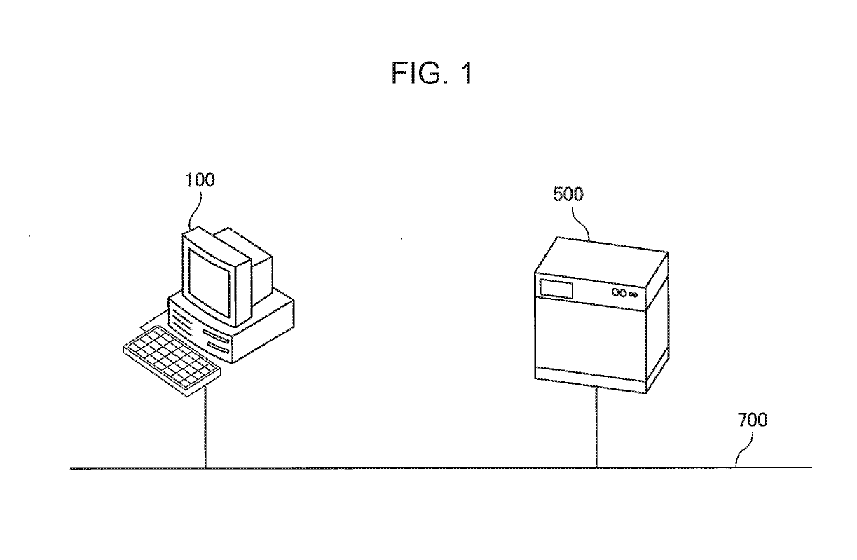

Now, an exemplary embodiment of the present invention will be described with reference to the drawings. FIG. 1 illustrates a three-dimensional shaping system 10 according to a first exemplary embodiment of the present invention. The three-dimensional shaping system 10 includes a data generation device 100 and a three-dimensional shaping device 500. The data generation device 100 and the three-dimensional shaping device 500 are connected to a network 700.

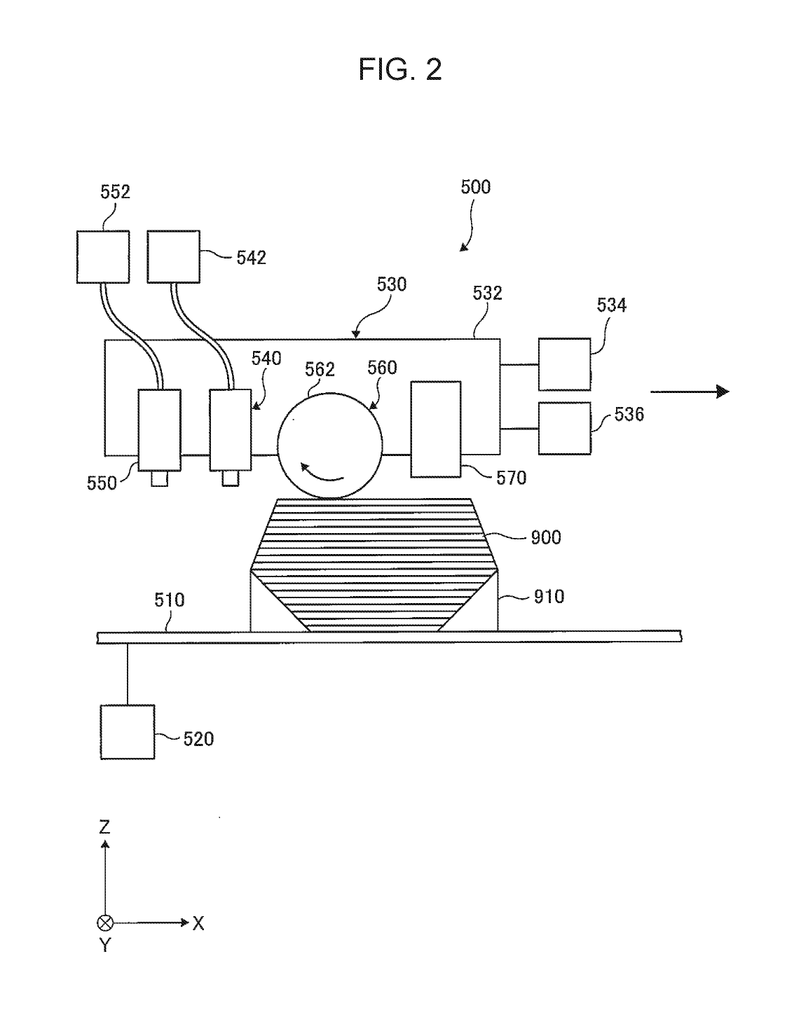

In the three-dimensional shaping system 10, the data generation device 100 generates three-dimensional data, the generated three-dimensional data are transmitted to the three-dimensional shaping device 500 via the network 700, and the three-dimensional shaping device 500 shapes a shaped object 900 (see FIG. 2) on the basis of the transmitted three-dimensional data.

A personal computer, for example, may be used as the data generation device 100. The data generation device 100 and the three-dimensional shaping device 500 will be discussed in detail later.

FIG. 2 illustrates the three-dimensional shaping device 500. The three-dimensional shaping device 500 adopts a so-called inkjet system, more particularly a so-called inkjet ultraviolet (UV)-curable laminate shaping system. In the following description, the inkjet UV-curable laminate shaping system is adopted for the three-dimensional shaping device 500. However, the three-dimensional shaping device 500 may adopt other systems. That is, the three-dimensional shaping device 500 may adopt a thermal dissolution lamination system referred to also as fused deposition modeling (FDM), a powder sintering system referred to also as selective laser sintering (SLS), a powder securing system, a plaster lamination system, a photo-shaping system referred to also as stereo lithography (STL), a sheet material lamination system referred to also as laminated object manufacturing (LOM), or the like, for example.

As illustrated in FIG. 2, the three-dimensional shaping device 500 includes a shaping stage 510. In the three-dimensional shaping device 500, the shaped object 900 is formed by laminating a shaping material on the upper surface of the shaping stage 510. In addition, a support material is laminated as necessary on the upper surface of the shaping stage 510 to form a support material lamination section 910.

The support material lamination section 910 is formed to support the shaped object 900 from the lower side in the case where the shaping material is not laminated on the lower side of a portion of the shaped object 900. The support material lamination section 910 is removed from the shaped object 900 by washing with water or the like, for example, after the shaped object 900 is shaped.

A Z-axis direction movement mechanism 520 is coupled to the shaping stage 510. The shaping stage 510 is movable in the Z-axis direction (vertical direction) by driving the Z-axis direction movement mechanism 520.

The three-dimensional shaping device 500 includes a head portion 530. The head portion 530 includes a head portion body 532. An X-axis direction movement mechanism 534 is coupled to the head portion body 532. The head portion 530 is movable in the X-axis direction (left-right direction in FIG. 2) by driving the X-axis direction movement mechanism 520. A Y-axis direction movement mechanism 536 is also coupled to the head portion body 532. The head portion 530 is movable in the Y-axis direction (the direction which crosses the sheet surface of FIG. 2) by driving the Y-axis direction movement mechanism 536.

The head portion 530 further includes a shaping material emission nozzle 540. The shaping material emission nozzle 540 emits the shaping material, which is stored in a shaping material storage section 542, toward the shaping stage 510. A photocurable resin may be used as the shaping material.

The head portion 530 further includes a support material emission nozzle 550. The support material emission nozzle 550 emits the support material, which is stored in a support material storage section 552, toward the shaping stage 510.

The head portion 530 includes a smoothing device 560. The smoothing device 560 smoothes the shaping material and the support material which are emitted toward the shaping stage 510. The smoothing device 560 includes a rotary member 562 that rotates to scrape off an excessive amount of the shaping material and an excessive amount of the support material, for example.

The head portion 530 includes a light irradiation device 570. The light irradiation device 570 irradiates light to cure the shaping material which is emitted toward the shaping stage 510, and to cure the support material which is emitted toward the shaping stage 510.

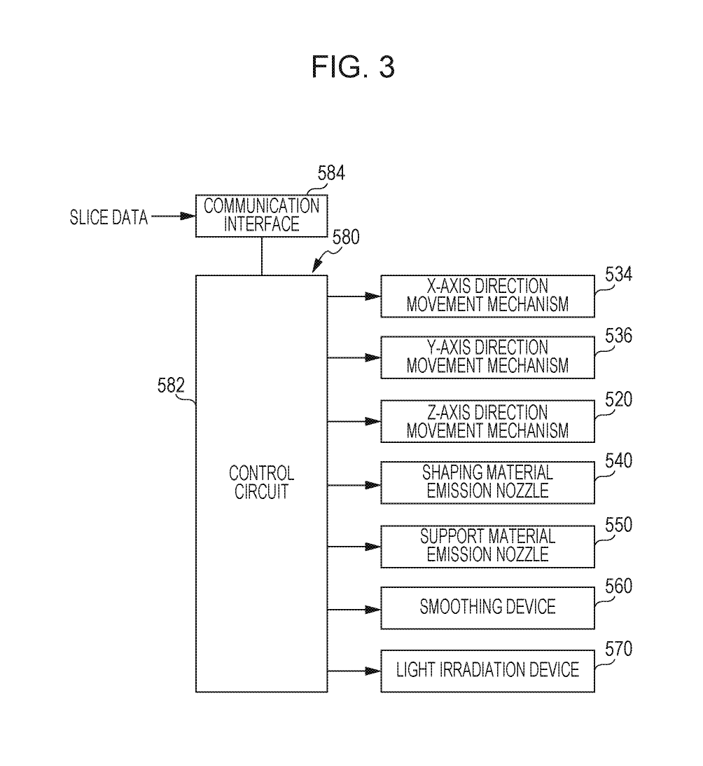

FIG. 3 is a block diagram illustrating a controller 580 of the three-dimensional shaping device 500. As illustrated in FIG. 3, the controller 580 includes a control circuit 582. Data generated by the data generation device 100 (see FIG. 1) are input to the control circuit 582 via the network 700 (see FIG. 1) and a communication interface 584.

In the three-dimensional shaping device 500, in addition, the X-axis direction movement mechanism 534, the Y-axis direction movement mechanism 536, the Z-axis direction movement mechanism 520, the shaping material emission nozzle 540, the support material emission nozzle 550, the smoothing device 560, and the light irradiation device 570 are controlled in accordance with an output from the control circuit 582.

In the three-dimensional shaping device 500 configured as described above, the control circuit 582 causes the shaping material emission nozzle 540 to emit the shaping material toward the shaping stage 510 and causes the support material emission nozzle 550 to emit the support material toward the shaping stage 510 while causing the X-axis direction movement mechanism 534 to move the head portion 530 rightward. Then, the control circuit 582 causes the smoothing device 560 to smooth the shaping material and the support material and causes the light irradiation device 570 to cure the shaping material and the support material while causing the X-axis direction movement mechanism 534 to move the head portion 530 leftward from the right side.

When shaping is finished for a certain width in the principal scanning direction (X-axis direction), the control circuit 582 causes the Y-axis direction movement mechanism 536 to move the head portion 530 in the sub scanning direction (Y-axis direction), and causes the components to repeat shaping for a certain width in the principal scanning direction.

When shaping of the shaped object is completed for one layer by repeating the above operation, the control circuit 582 causes the Z-axis direction movement mechanism 520 to move the shaping stage 510 downward (Z-axis direction) for an amount corresponding to the thickness of one layer of the shaped object 900. Then, the control circuit 582 causes the components to shape the next layer of the shaped object 900 as laminated on the portion of the shaped object 900 which has already been shaped. By repeating the above operation, the three-dimensional shaping device 500 shapes the shaped object 900 in which layers of the cured shaping material are laminated.

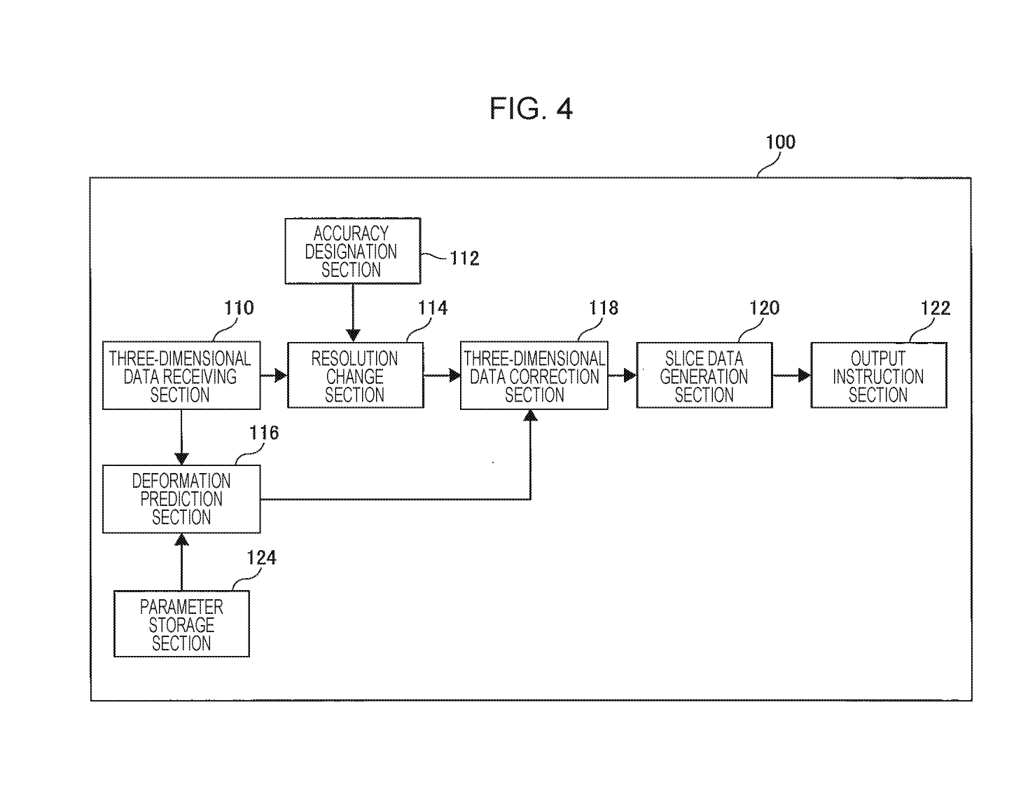

FIG. 4 is a block diagram illustrating the functional configuration of the data generation device 100. As illustrated in FIG. 4, the data generation device 100 includes a three-dimensional data receiving section 110. The three-dimensional data receiving section 110 receives three-dimensional data. In the exemplary embodiment, the three-dimensional data receiving section 110 receives Standard Triangulated Language (STL) data as the three-dimensional data. However, the three-dimensional data receiving section 110 may receive three-dimensional computer aided design (CAD) data, three-dimensional computer graphics (CG) data, data from a three-dimensional (3D) scanner, or the like, and the received data may be converted into the STL data on the data generation device 100 side.

The STL data are data in an STL format, which is one of file formats for saving data that represent a three-dimensional shape. In the STL format, three-dimensional data are indicated by the coordinates of the vertexes of a large number of triangles and the normal vectors to the surfaces of the large number of triangles.

The data generation device 100 further includes an accuracy designation section 112. The accuracy designation section 112 designates the accuracy of three-dimensional data (STL data) on the basis of an operation by an operator, for example.

The data generation device 100 further includes a resolution change section 114. The resolution change section 114 changes the resolution of the three-dimensional data (STL data), which are received by the three-dimensional data receiving section 110, as necessary on the basis of the accuracy designated by the accuracy designation section 112. In this event, it is desirable that the resolution change section 114 should individually change the resolutions in the X-axis direction, the Y-axis direction, and the Z-axis direction on the basis of the respective accuracies in the directions of the three axes of the three-dimensional shaping device 500, that is, the respective accuracies of the X-axis direction movement mechanism 534, the Y-axis direction movement mechanism 536, and the Z-axis direction movement mechanism 520.

For example, in the exemplary embodiment, the accuracy of the Z-axis direction movement mechanism 520 is lower than the accuracy of the X-axis direction movement mechanism 534 and the accuracy of the Y-axis direction movement mechanism 536. Therefore, the resolution change section 114 changes the resolution of the three-dimensional data such that the resolution of the data in the Z-axis direction is lower than the resolution of the data in the X-axis direction and the resolution of the data in the Y-axis direction. The resolution change section 114 will be discussed in detail later.

The data generation device 100 further includes a deformation prediction section 116. The deformation prediction section 116 predicts deformation of the shaped object 900 after being shaped, from a shape prescribed by the three-dimensional data which are received by the three-dimensional data receiving section 100, on the basis of the shape prescribed by the three-dimensional data in accordance with the geometric shape of the shaped object. More particularly, the deformation prediction section 116 predicts deformation of the shaped object 900 after being shaped, from the shape prescribed by the three-dimensional data, using parameters stored in a parameter storage section 124 in accordance with the geometric shape of the three-dimensional data. The deformation prediction section 116 will be discussed in detail later.

The data generation device 100 further includes the parameter storage section 124. As discussed earlier, the parameter storage section 124 stores the parameters which are used when the deformation prediction section 116 predicts deformation of the shaped object 900 after being shaped, and which are measured in accordance with the geometric shape prescribed by the three-dimensional data. More specifically, the parameter storage section 124 stores parameters in accordance with an acuteness degree f(e) to be discussed later, which is a value that indicates the shape of a ridge line portion of the three-dimensional data.

The data generation device 100 further includes a three-dimensional data correction section 118. The three-dimensional data correction section 118 corrects the three-dimensional data so as to reduce deformation of the shaped object 900 after being shaped, from the shape prescribed by the three-dimensional data, on the basis of the prediction by the deformation prediction section 116. The three-dimensional data correction section 118 will be discussed in detail later.

The data generation device 100 further includes a slice data generation section 120. The slice data generation section 120 converts the three-dimensional data into slice data (lamination data) obtained by slicing the three-dimensional data in the horizontal direction, for example.

The data generation device 100 further includes an output instruction section 122. The output instruction section 122 instructs the three-dimensional shaping device 500 to shape the shaped object 900 on the basis of the lamination data generated by the slice data generation section 120.

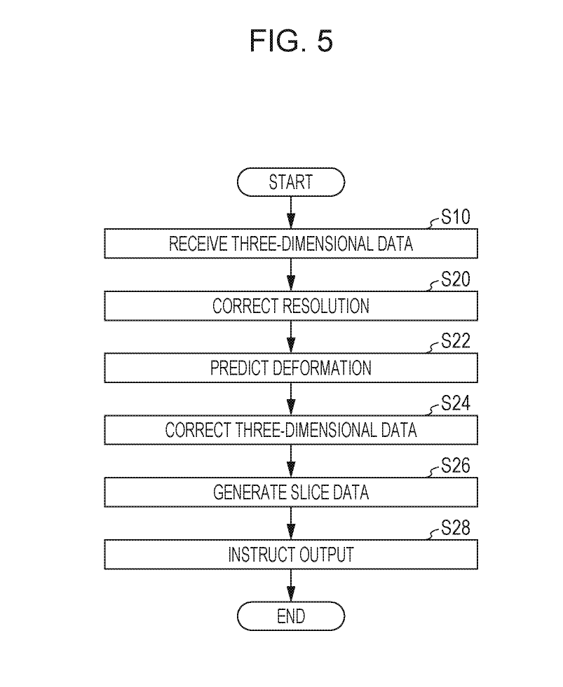

FIG. 5 is a flowchart illustrating the steps of the data generation by the data generation device 100. In step S10, which is the first step, the three-dimensional data receiving section 110 receives three-dimensional data such as STL data, for example.

In the next step S20, the resolution change section 114 changes the resolution of the three-dimensional data on the basis of an instruction from the accuracy designation section 112.

In the next step S22, the deformation prediction section 116 predicts deformation of the shaped object 900 after being shaped, from the shape prescribed by the three-dimensional data, using the parameters stored in the parameter storage section 124 on the basis of the geometric shape of the shaped object 900.

In the next step S24, the three-dimensional data correction section 118 corrects the three-dimensional data so as to reduce deformation of the shaped object 900 on the basis of the prediction by the deformation prediction section 116.

In the next step S26, the slice data generation section 120 converts the three-dimensional data to generate slice data.

In the next step S28, the output instruction section 122 instructs the three-dimensional shaping device 500 to shape the shaped object 900.

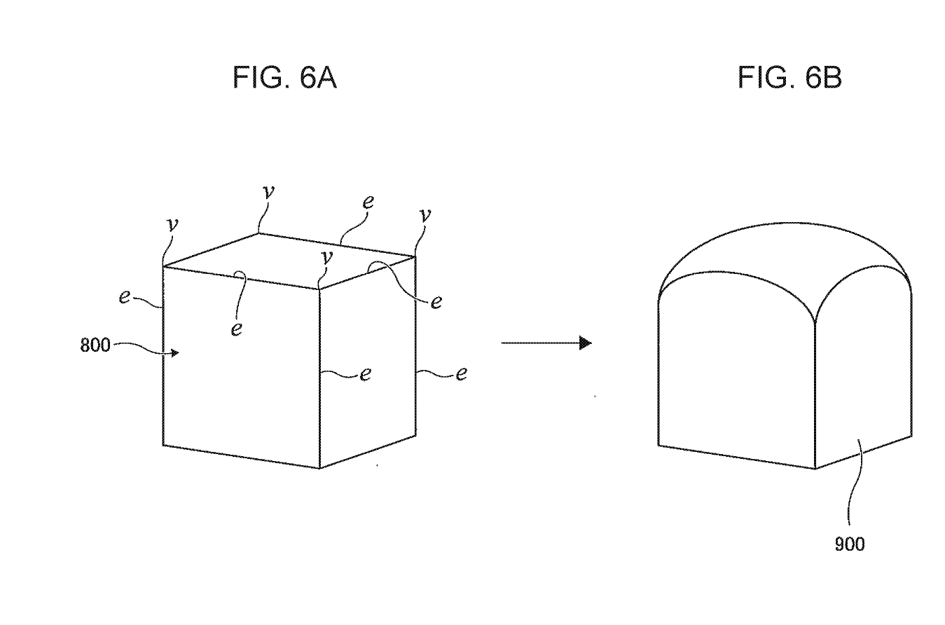

FIGS. 6A and 6B illustrate an example of deformation of the shaped object 900 after being shaped, from the shape prescribed by the three-dimensional data, for a case where a common three-dimensional shaping system is used. In this example, the shaped object 900 after being shaped illustrated in FIG. 6B has been deformed from a shape 800 prescribed by the three-dimensional data illustrated in FIG. 6A. It is seen that the deformation tends to be caused particularly on ridge lines e and vertexes v of the shape 800 prescribed by the three-dimensional data.

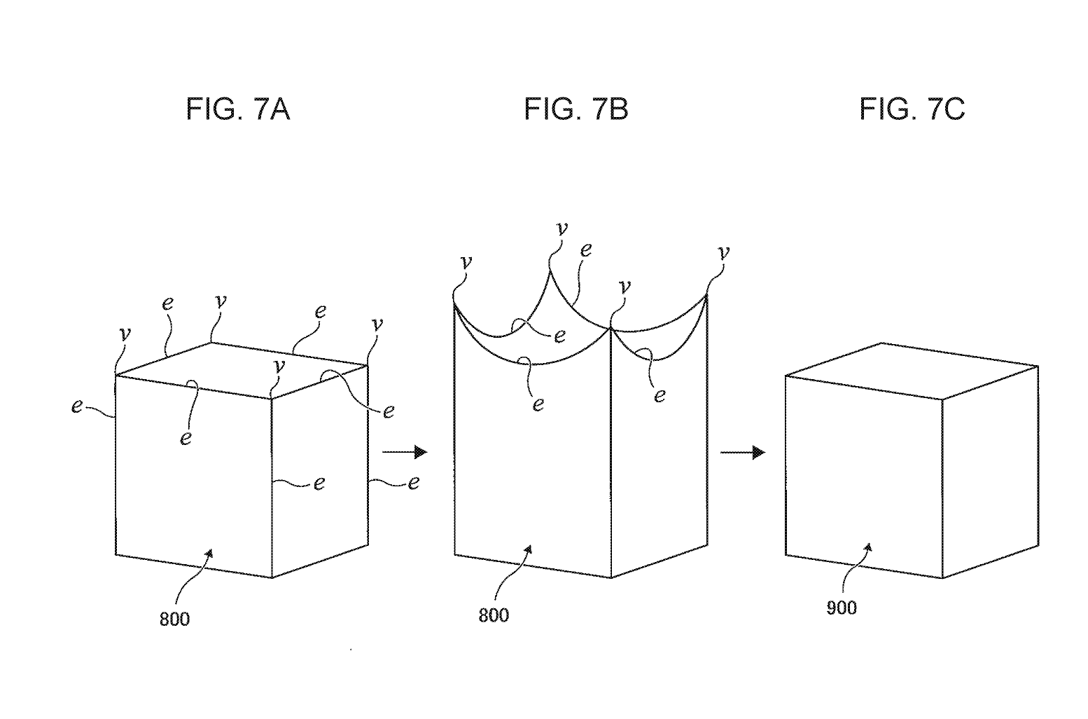

FIGS. 7A to 7C illustrate an example of deformation of the shaped object 900 after being shaped, from the shape prescribed by the three-dimensional data, for a case where the three-dimensional shaping system 10 according to the first exemplary embodiment of the present invention is used. In this example, FIG. 7A illustrates the shape 800 of the shaped object prescribed by the three-dimensional data received by the three-dimensional data receiving section 110. FIG. 7B illustrates the shape of the shaped object prescribed by the three-dimensional data corrected by the three-dimensional data correction section 118 on the basis of the prediction by the deformation prediction section 116. FIG. 7C illustrates the shape of the shaped object 900 shaped by the three-dimensional shaping device 500 on the basis of the three-dimensional data corrected by the three-dimensional data correction section 118.

The three-dimensional data correction section 118 corrects the three-dimensional data so as to reduce deformation of the shaped object after being shaped by the three-dimensional shaping device 500, from the shape prescribed by the three-dimensional data, preferably so as to cancel deformation. More specifically, the three-dimensional data correction section 118 corrects the three-dimensional data so as to cancel contraction of the ridge lines e and the vertexes v to be contracted when shaping is performed by the three-dimensional shaping device 500.

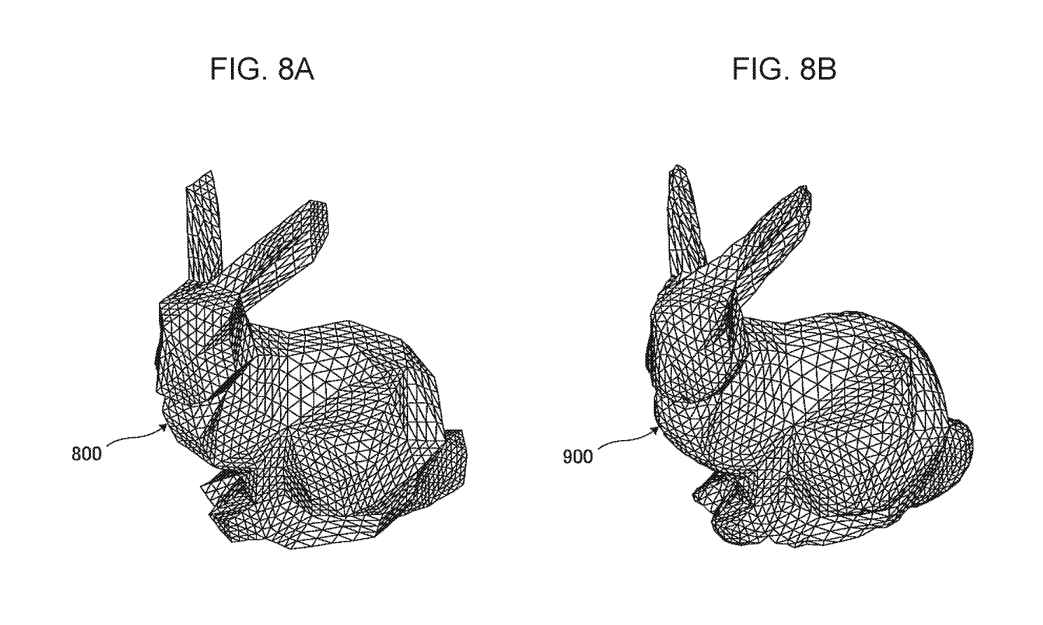

FIGS. 8A and 8B illustrate another example of deformation of the shaped object 900 after being shaped, from the shape prescribed by the three-dimensional data, for a case where the three-dimensional shaping system 10 according to the first exemplary embodiment of the present invention is used. In this example, FIG. 8A illustrates the shape of the shaped object prescribed by the three-dimensional data corrected by the three-dimensional data correction section 118 on the basis of the prediction by the deformation prediction section 116. The three-dimensional data illustrated in FIGS. 8A and 8B are the STL data discussed earlier. FIG. 8B illustrates the shape of the shaped object 900 shaped by the three-dimensional shaping device 500 on the basis of the three-dimensional data corrected by the three-dimensional data correction section 118. The triangles on the surface of the shaped object 900 in FIGS. 8A and 8B are depicted to facilitate comparison between the three-dimensional data illustrated in FIG. 8A and the shape of the shaped object 900 after being shaped, and are not depicted on the surface of the shaped object 900.

Also in this example, as seen from comparison between FIGS. 8A and 8B, the three-dimensional data correction section 118 corrects the three-dimensional data so as to reduce deformation of the shaped object after being shaped by the three-dimensional shaping device 500, from the shape prescribed by the three-dimensional data, preferably so as to cancel deformation.

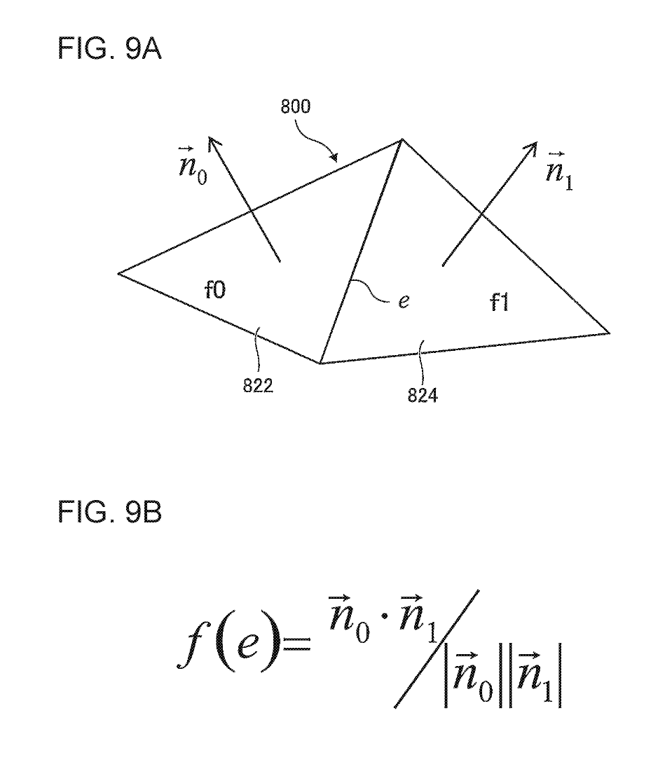

FIGS. 9A and 9B illustrate an algorithm for calculating an acuteness degree of the ridge line e for predicting deformation of the shaped object 900 from the three-dimensional data, which is at least a part of an algorithm for the deformation prediction section 116 to predict deformation of the shaped object 900 after being shaped from the three-dimensional data. FIG. 9A illustrates three-dimensional data including the ridge line e, the acuteness degree of which is to be calculated. FIG. 9B indicates an expression that defines the acuteness degree of the ridge line e.

As illustrated in FIG. 9A, the ridge line e is shared by a triangle 822 prescribed by the STL data and having a surface f0, and a triangle 824 prescribed by the STL data and having a surface f1. As indicated in FIG. 9B, the acuteness degree f(e) of the ridge line e is defined as the inner product of a normal vector to the surface f0 of the triangle 822 with a length of 1 and a normal vector to the surface f1 of the triangle 822 with a length of 1. The acuteness degree f(e) defined as discussed above may have a value of −1 to 1, and indicates that the ridge line e is more acute as the value is smaller.

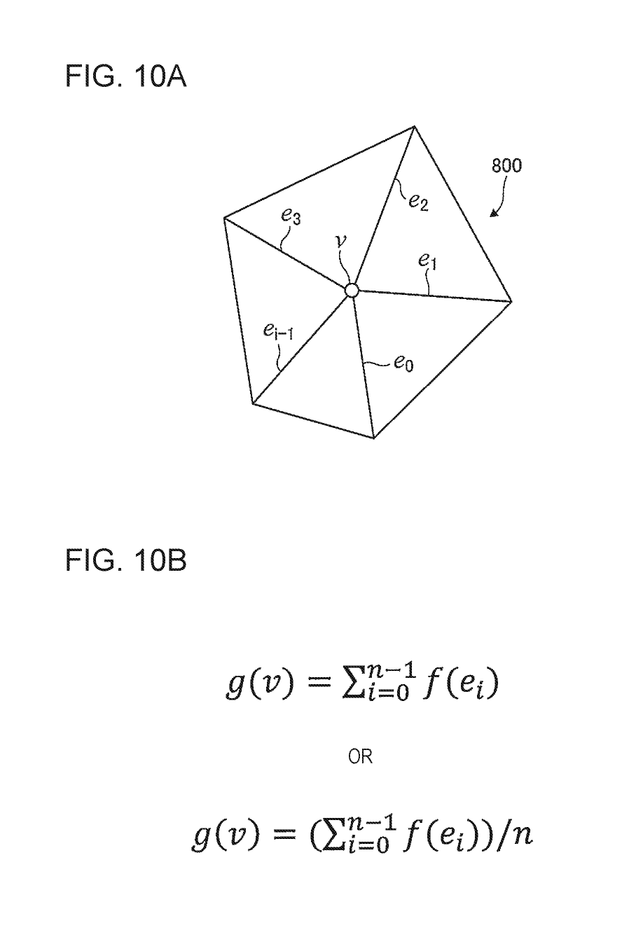

FIGS. 10A and 10B illustrate an algorithm for calculating an acuteness degree of the vertex v in the three-dimensional data for predicting deformation of the shaped object 900, which is at least a part of the algorithm for the deformation prediction section 116 to predict deformation of the shaped object 900 after being shaped from the three-dimensional data. FIG. 10A illustrates three-dimensional data including the vertex v, the acuteness degree of which is to be calculated. FIG. 10B indicates an expression that defines the acuteness degree of the vertex v.

As illustrated in FIG. 10A, the vertex v is formed as being shared by n (in the example illustrated in FIG. 10A, n=5) ridge lines e. As indicated in FIG. 10B, an acuteness degree g(v) of the vertex v is calculated as the sum of the respective acuteness degrees f(e) of the n ridge lines e, or as the average of the respective acuteness degrees f(e) of the n ridge lines e.

The deformation prediction section 116 predicts deformation of the shaped object 900 after being shaped as follows. Deformation of the shaped object 900 after being shaped from the three-dimensional data is larger for the ridge line e, the value of the acuteness degree f(e) discussed above of which is smaller. Deformation of the shaped object 900 after being shaped from the three-dimensional data is larger for the vertex v, the value of the acuteness degree g(v) discussed above of which is smaller.

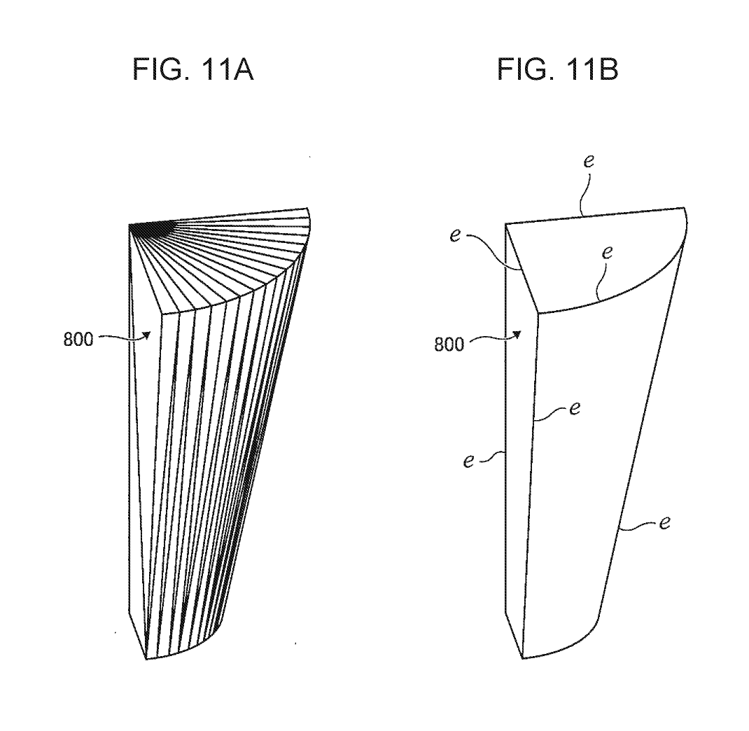

FIGS. 11A and 11B illustrate an example of the result of calculating the acuteness degree. FIG. 11A illustrates an example of the shape 800 prescribed by the three-dimensional data as the STL data. FIG. 11B illustrates only the ridge lines e of the shape 800 illustrated in FIG. 11A with an acuteness degree f(e) of less than 0.3.

The deformation prediction section 116 predicts deformation of the ridge line e and deformation of the vertex v using the acuteness degree f(e) of the ridge line e and the acuteness degree g(v) of the vertex v calculated as described above, and the parameters stored in the parameter storage section 124.

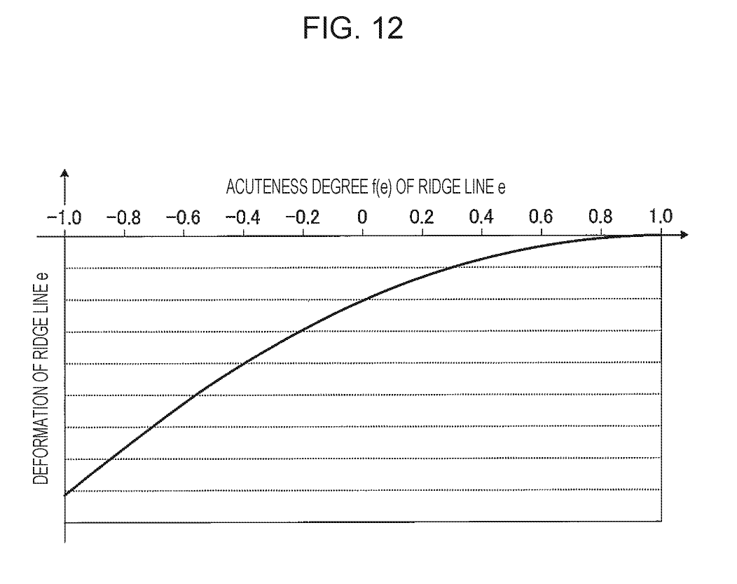

FIG. 12 illustrates an example of the parameters stored in the parameter storage section 124. As illustrated in FIG. 12, the parameter storage section 124 stores measured values of the acuteness degree f(e) of the ridge line e and the magnitude of deformation of the ridge line e. In this example, the ridge line e is contracted to a larger degree as the acuteness degree f(e) of the ridge line e is smaller and the ridge line e is more acute (the ridge line e is more pointed), and the ridge line e is contracted to a smaller degree as the acuteness degree f(e) is larger. Therefore, the deformation prediction section 116 predicts that the ridge line e with a smaller acuteness degree f(e) is contracted to a larger degree, and that the ridge line e with a larger acuteness degree f(e) is contracted to a smaller degree.

The parameter storage section 124 stores the parameters discussed above for each combination of the material used for shaping and the three-dimensional shaping device 500 which performs shaping.

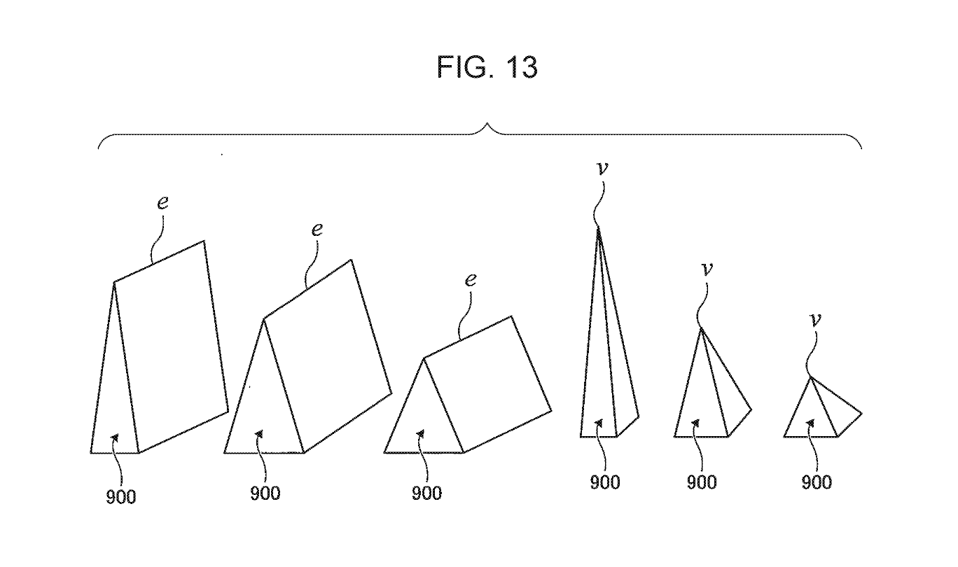

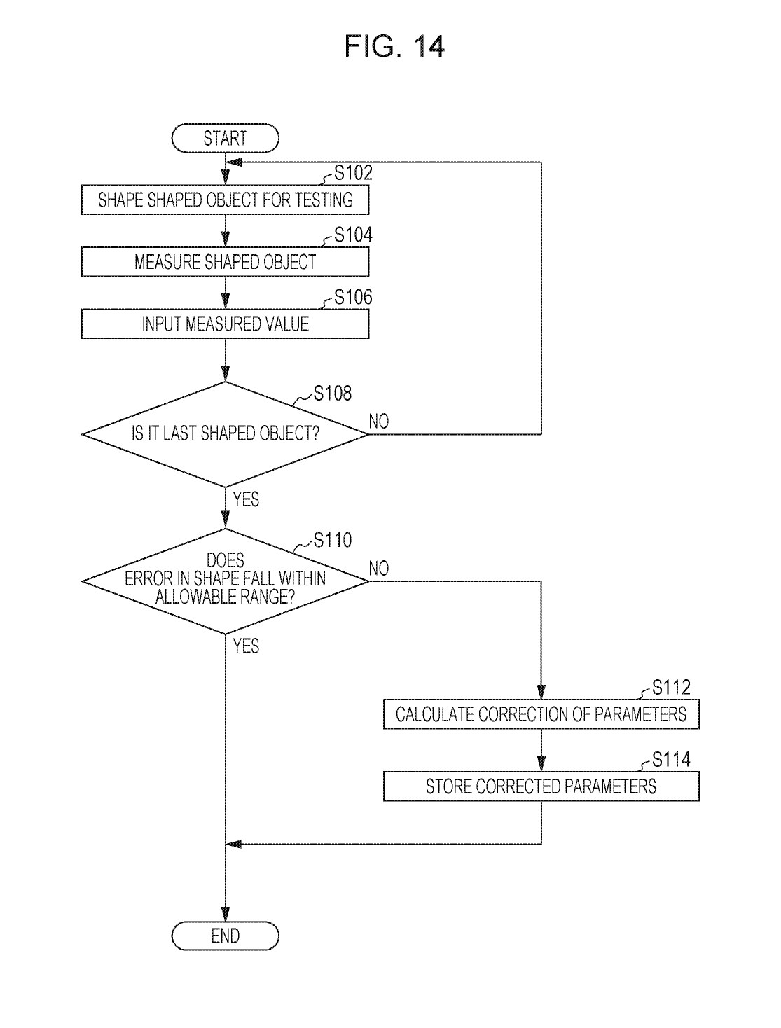

FIG. 13 illustrates shaped objects 900 for testing shaped to correct the parameters stored in the parameter storage section 124. FIG. 14 is a flowchart illustrating a process for correcting the parameters stored in the parameter storage section 124.

To correct the parameters, plural shaped objects 900 are shaped for testing, for example. As illustrated in FIG. 13, in the case where plural shaped objects 900 are shaped for testing, the plural shaped objects 900 for testing are shaped such that the respective acuteness degrees f(e) of the ridge lines e of the plural shaped objects 900 for testing are different from each other, or such that the respective acuteness degrees g(v) of the vertexes v of the plural shaped objects 900 for testing are different from each other.

In order to correct the parameters, as illustrated in FIG. 14, in the first step S102, the operator causes the three-dimensional shaping device 500 to shape a shaped object 900 for testing. The shaped object 900 for testing to be shaped is one of the shaped objects 900 for testing illustrated in FIG. 13.

In the next step S104, the shaped object 900 shaped in step S102 is measured. In the measurement, a three-dimensional scanner (not illustrated) may be used, or the operator may measure the shaped object 900 using a measurement instrument (not illustrated) such as vernier calipers in the case where the shape of the shaped object 900 is simple, for example.

In the next step S106, the value obtained through the measurement in step S104 is input to the data generation device 100, for example. The measurement data may be input to the data generation device 100 by connecting the three-dimensional scanner to the network 700 and transferring the measurement data to the data generation device 100 via the network 700, or by inputting the numerical value obtained through the measurement using the vernier calipers to the data generation device 100 using a keyboard or the like attached to the data generation device 100.

In the next step S108, it is determined whether or not the shaped object 900, the measured value for which is input in step S106, is the last one of the shaped objects 900 to be shaped for testing (e.g. of the six shaped objects illustrated in FIG. 13). If the shaped object 900 is not the last shaped object, step S102, step S104, and step S106 are repeated for the shaped objects 900 which have not been shaped for testing.

In the next step S110, for example, the control circuit 582 makes a comparison between the three-dimensional data on the shaped object 900 to be shaped for testing and the measured value for the shaped object 900 after being shaped, and determines whether or not an error of the shape of the shaped object 900 after being shaped from the three-dimensional data falls within an allowable range.

A comparison may be made between the shape of the shaped object prescribed by the three-dimensional data and the measured value for the shaped object 900 measured using the vernier calipers, for example, and the operator may determine whether or not an error in shape falls within an allowable range, rather than the measured value is input to the data generation device 100 or the like in step S106 and the control circuit 582 of the data generation device 100 determines whether or not an error in shape falls within an allowable range in step S110.

In the case where it is determined in step S110 that the error in shape falls within the allowable range, the sequence of the processes is finished, considering that it is not necessary to correct the parameters.

In the case where it is determined in step S110 that the error in shape exceeds the allowable range, on the other hand, the controller 582 corrects the parameters so as to make the error in shape smaller in step S112, and the corrected parameters are stored in the parameter storage section 124 in step S114, for example.

The deformation prediction section 116 not only predicts deformation of the ridge lines e and the vertexes v, but also predicts deformation of portions other than the ridge lines e and the vertexes v. The prediction of deformation of portions other than the ridge lines e and the vertexes v by the deformation prediction section 116 will be described below.

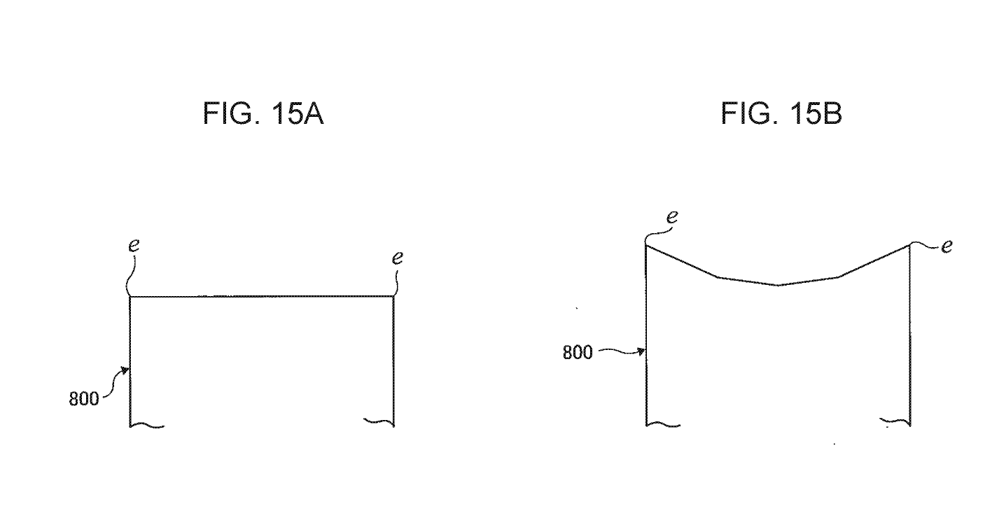

FIGS. 15A and 15B illustrate an algorithm for predicting deformation at positions other than the ridge lines e and the vertexes v, which is at least a part of an algorithm for the deformation prediction section 116 to predict deformation of the shaped object 900 after being shaped from the three-dimensional data. The deformation prediction section 116 calculates the value of the acuteness degree f(e) of the ridge lines e of the shape prescribed by the three-dimensional data illustrated in FIG. 15A. The deformation prediction section 116 determines the acuteness degree at positions other than the ridge lines e such that the acuteness degree is larger at positions closer to the ridge lines e and the acuteness degree is smaller at positions farther from the ridge lines e. FIG. 15B illustrates the shape 800 prescribed by the three-dimensional data corrected by the three-dimensional data correction section 118 on the basis of the results of the prediction by the deformation prediction section 116 using the algorithm discussed above.

In the above description, the acuteness degree at positions other than the ridge lines e and the vertexes v is predicted on the basis of the distance from the ridge lines e. However, the acuteness degree at positions other than the ridge lines e and the vertexes v may be predicted on the basis of the distance from the vertexes v. Alternatively, the acuteness degree at positions other than the ridge lines e and the vertexes v may be predicted on the basis of both the distance from the ridge lines e and the distance from the vertexes v.

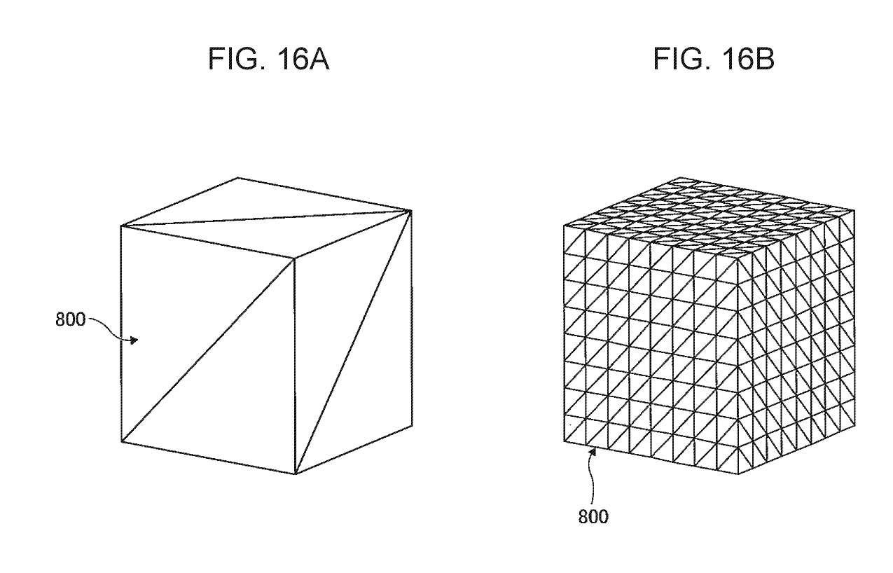

FIGS. 16A and 16B illustrate a first example of a change in resolution of the three-dimensional data made by the resolution change section 114. FIG. 16A illustrates the shape 800 prescribed by the three-dimensional data received by the three-dimensional data receiving section 110. FIG. 16B illustrates the shape 800 prescribed by the three-dimensional data with the resolution enhanced by the resolution change section 114. If the resolution of the three-dimensional data is too low, the three-dimensional data correction section 118 may not be able to correct the three-dimensional data. Therefore, the three-dimensional data correction section 118 performs a process for increasing the resolution so that the three-dimensional data correction section 118 may be able to correct the three-dimensional data. In the first example, the three-dimensional data are in the STL format, and the polygons that constitute the data are triangles.

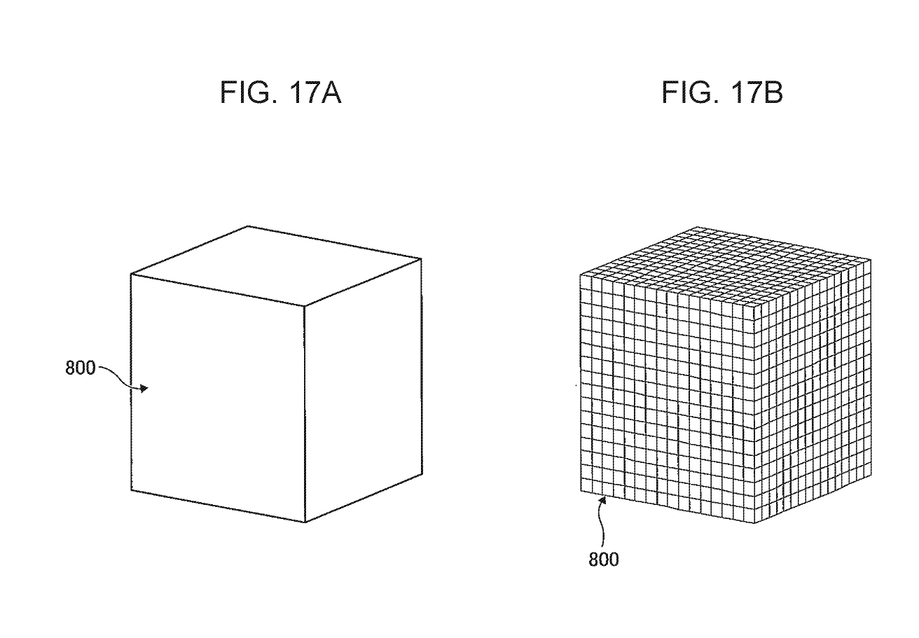

FIGS. 17A and 17B illustrate a second example of a change in resolution of the three-dimensional data made by the resolution change section 114. FIG. 17A illustrates the shape 800 prescribed by the three-dimensional data received by the three-dimensional data receiving section 110. FIG. 17B illustrates the shape 800 prescribed by the three-dimensional data with the resolution enhanced by the resolution change section 114. In the first example discussed earlier, the polygons that constitute the three-dimensional data are triangles. In the second example, however, the polygons that constitute the three-dimensional data are rectangles.

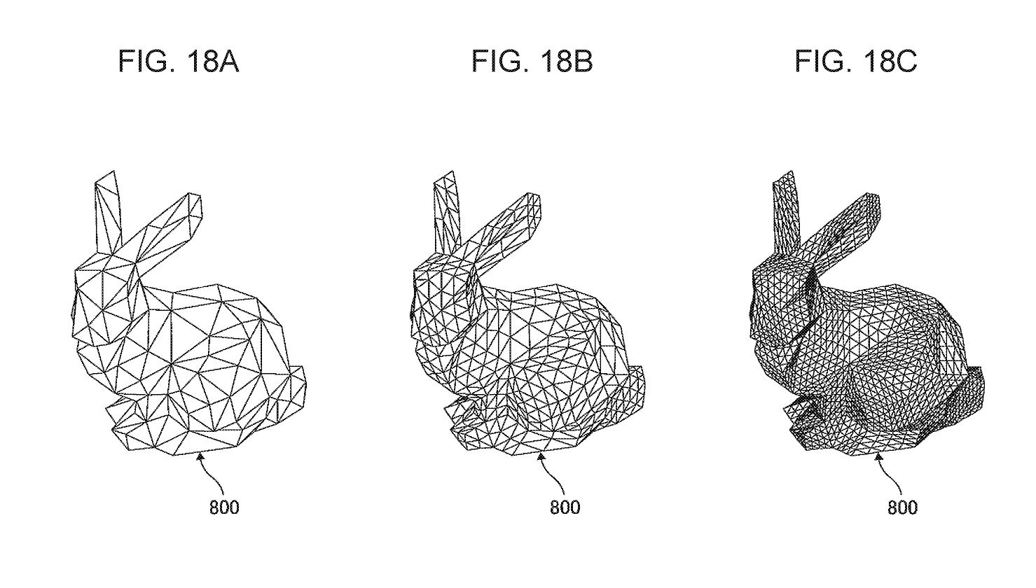

FIG. 18A to 18C illustrate a third example of a change in resolution of the three-dimensional data made by the resolution change section 114. FIG. 18A illustrates the shape 800 prescribed by the three-dimensional data received by the three-dimensional data receiving section 110. FIG. 18B illustrates the shape 800 prescribed by the three-dimensional data with the resolution enhanced by the resolution change section 114. FIG. 18C illustrates the shape 800 prescribed by the three-dimensional data with the resolution further enhanced by the resolution change section 114.

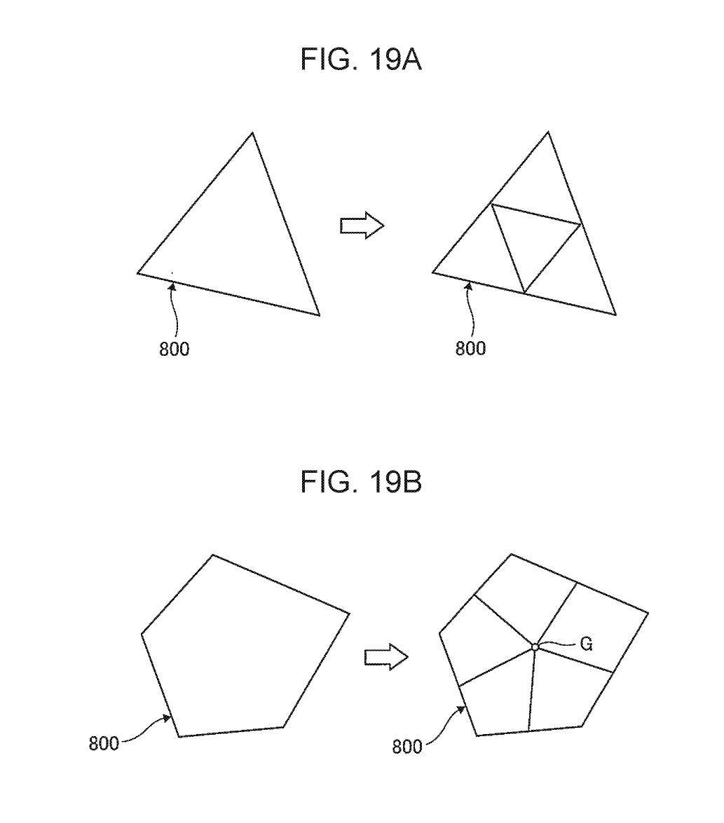

FIGS. 19A and 19B illustrate an algorithm for the resolution change section 114 to enhance the resolution of the three-dimensional data. FIG. 19A illustrates an algorithm for a case where the polygons that constitute the three-dimensional data are triangles. FIG. 19B illustrates an algorithm for a case where the polygons that constitute the three-dimensional data are not triangles.

As illustrated in FIG. 19A, in the case where the polygons are triangles, the resolution change section 114 enhances the resolution of the three-dimensional data by connecting the respective midpoints of the two sides extending from each vertex of each triangle to form new triangles.

As illustrated in FIG. 19B, in the case where the polygons are not triangles, meanwhile, the resolution change section 114 enhances the resolution of the three-dimensional data by connecting a center of gravity G of each polygon and the respective midpoints of the sides of the polygon to form new polygons. In the case where the polygons are concave polygons having a concave portion, each concave polygon is divided into two convex polygons (polygons not having a concave portion), for example, and thereafter the process discussed above is performed for each convex polygon.

In the above description, the resolution change section 114 enhances the resolution of the three-dimensional data. However, the resolution change section 114 may lower the resolution of the three-dimensional data. In an example of a case where the resolution change section 114 lowers the resolution of the three-dimensional data, the resolution of the three-dimensional data is lowered so that the three-dimensional data correction section 118 finishes correcting the three-dimensional data in a short time.

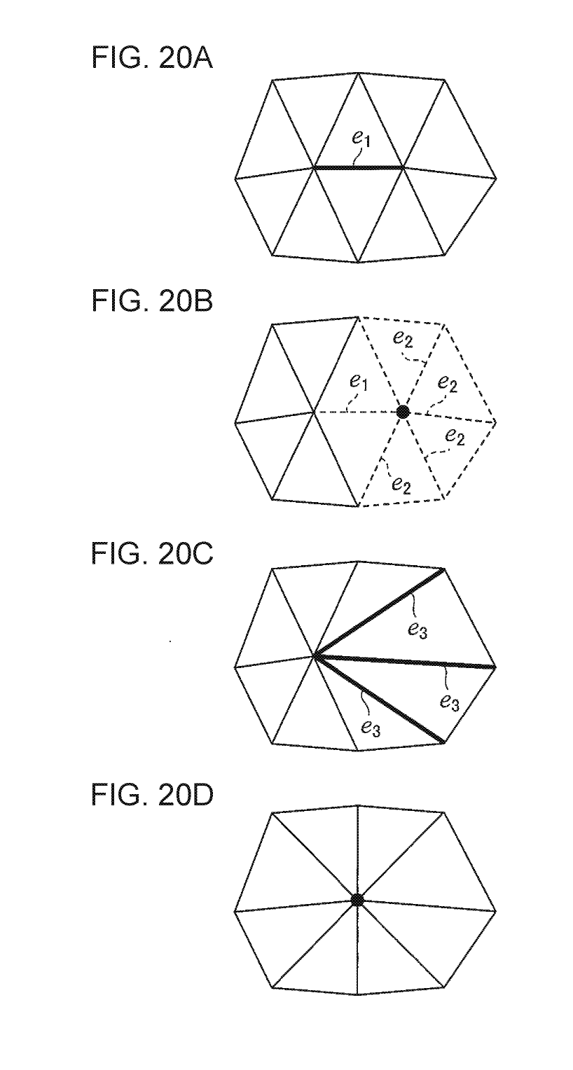

FIGS. 20A to 20D illustrate a first example of an algorithm for the resolution change section 114 to lower the resolution of the three-dimensional data. In this first algorithm, the resolution change section 114 preferentially deletes a ridge line e with a smaller acuteness degree f(e) than that of the other ridge lines e, among the ridge lines e of the shape prescribed by the three-dimensional data.

FIG. 20A illustrates the three-dimensional data received by the three-dimensional data receiving section 110. The resolution change section 114 computes the acuteness degree of each ridge line of the three-dimensional data, and selects the ridge line e with the smallest acuteness degree. In the following description, it is assumed that a ridge line e₁ indicated by a thick line in FIG. 20A has been selected as the ridge line with the smallest acuteness degree.

As illustrated in FIG. 20B, the resolution change section 114 first deletes the ridge line e₁ (indicated by a dotted line in FIG. 20B), and further deletes all the ridge lines e₂ (indicated by dotted lines in FIG. 20B) that extend from one of the vertexes of the deleted ridge line e₁.

Next, as illustrated in FIG. 20C, the resolution change section 114 forms new ridge lines e₃ that extend diagonally from the other of the vertexes of the deleted ridge line e₁.

Then, as illustrated in FIG. 20D, the resolution change section 114 moves the other vertex of the deleted ridge line e₁ to the center of the deleted ridge line e₁.

In the first algorithm, the above processes are repeated as appropriate to lower the resolution of the three-dimensional data.

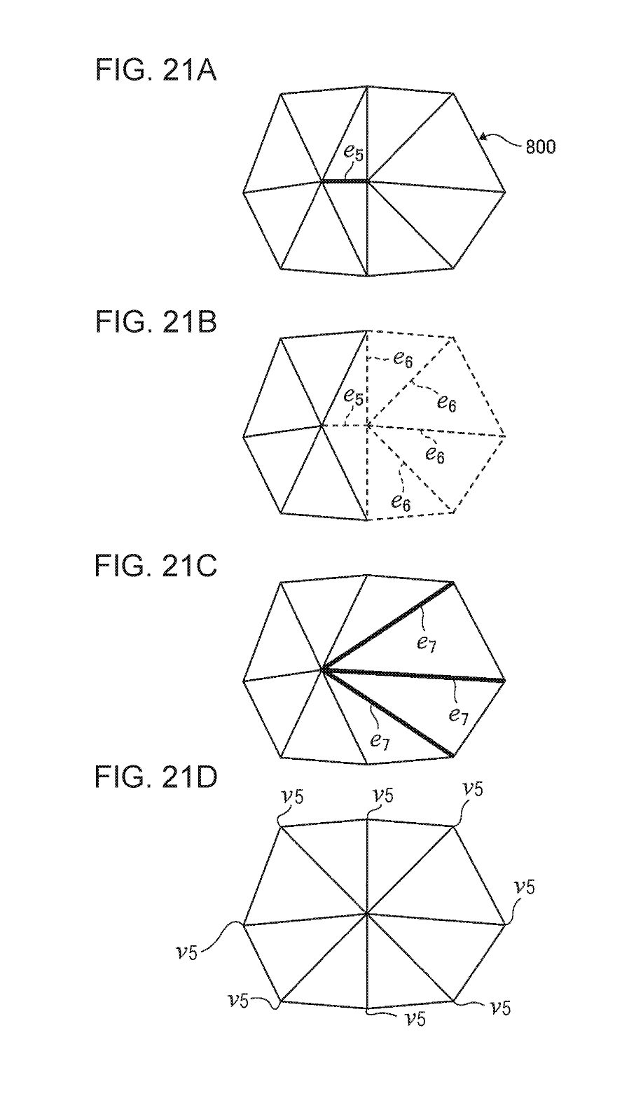

FIGS. 21A to 21D illustrate a second example of an algorithm for the resolution change section 114 to lower the resolution of the three-dimensional data. In this second algorithm, the resolution change section 114 preferentially deletes a ridge line e that is shorter than the other ridge lines e, among the ridge lines e of the shape 800 prescribed by the three-dimensional data. Instead of deleting a ridge line e that is shorter than the other ridge lines e, one of the three ridge lines e that form a triangle, the triangle formed by which is not analogous to a regular triangle compared to the triangles formed by the other two ridge lines e, may be deleted.

FIG. 21A illustrates the shape 800 prescribed by the three-dimensional data received by the three-dimensional data receiving section 110. The resolution change section 114 selects the shortest ridge line e. In the following description, it is assumed that a ridge line e₅ indicated by a thick line in FIG. 21A has been selected as the shortest ridge line.

As illustrated in FIG. 21B, the resolution change section 114 first deletes the ridge line e₅ (indicated by a dotted line in FIG. 21B), and further deletes all the ridge lines e₆ (indicated by dotted lines in FIG. 21B) that extend from one of the vertexes of the deleted ridge line e₅.

Next, as illustrated in FIG. 21C, the resolution change section 114 forms new ridge lines e₇ that extend diagonally from the other of the vertexes of the deleted ridge line e₅.

Then, as illustrated in FIG. 21D, the resolution change section 114 moves the other vertex of the deleted ridge line e₅ to the average coordinate of vertexes v5 of the surrounding triangles excluding the other vertex itself.

In the second algorithm, the above processes are repeated as appropriate to lower the resolution of the three-dimensional data.

The resolution change section 114 may not only change the three-dimensional data so as to enhance or lower the resolution of the three-dimensional data as discussed above, but also change the three-dimensional data so as to reduce the non-uniformity in resolution of the three-dimensional data in the case where the resolution of the three-dimensional data is non-uniform among the positions.

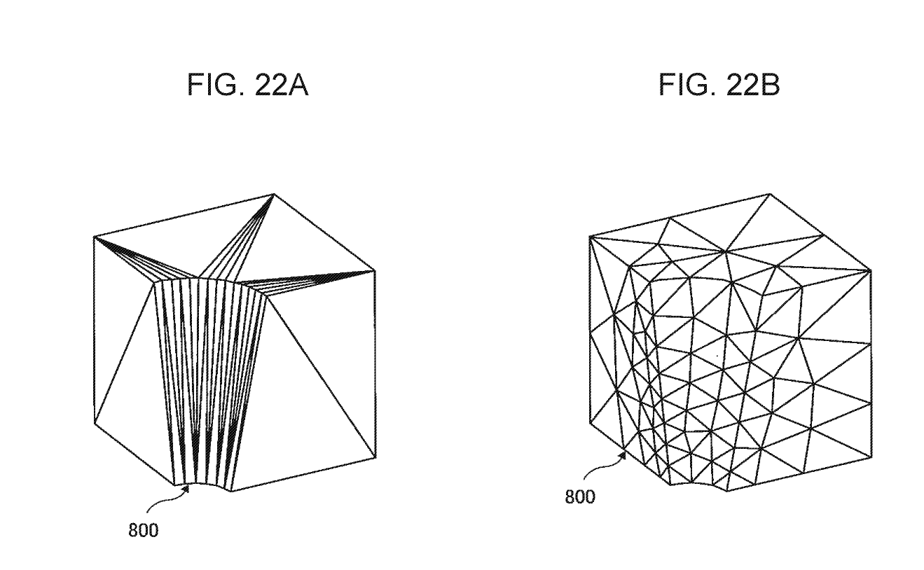

FIGS. 22A and 22B illustrate a fourth example of a change in resolution of the three-dimensional data made by the resolution change section 114. In the fourth example, the resolution change section 114 changes the resolution of the three-dimensional data so as to reduce the non-uniformity (homogenize the polygons) among the positions. FIG. 22A illustrates the three-dimensional data received by the three-dimensional data receiving section 110. FIG. 22B illustrates three-dimensional data with the resolution changed as the resolution change section 114 remeshes the three-dimensional data so as to reduce the non-uniformity in resolution among the positions.

In order to homogenize the density of the three-dimensional data, for example, polygons may be deleted, and three-dimensional data constituted by polygons that are more uniform than the deleted polygons may be generated. In the example illustrated in FIGS. 22A and 22B, three-dimensional data with triangular polygons are changed into three-dimensional data with rectangular polygons.

As discussed earlier, the resolution change section 114 occasionally individually changes the resolutions in the X-axis direction, the Y-axis direction, and the Z-axis direction on the basis of the respective accuracies in the directions of the three axes of the three-dimensional shaping device 500, that is, the respective accuracies of the X-axis direction movement mechanism 534, the Y-axis direction movement mechanism 536, and the Z-axis direction movement mechanism 520.

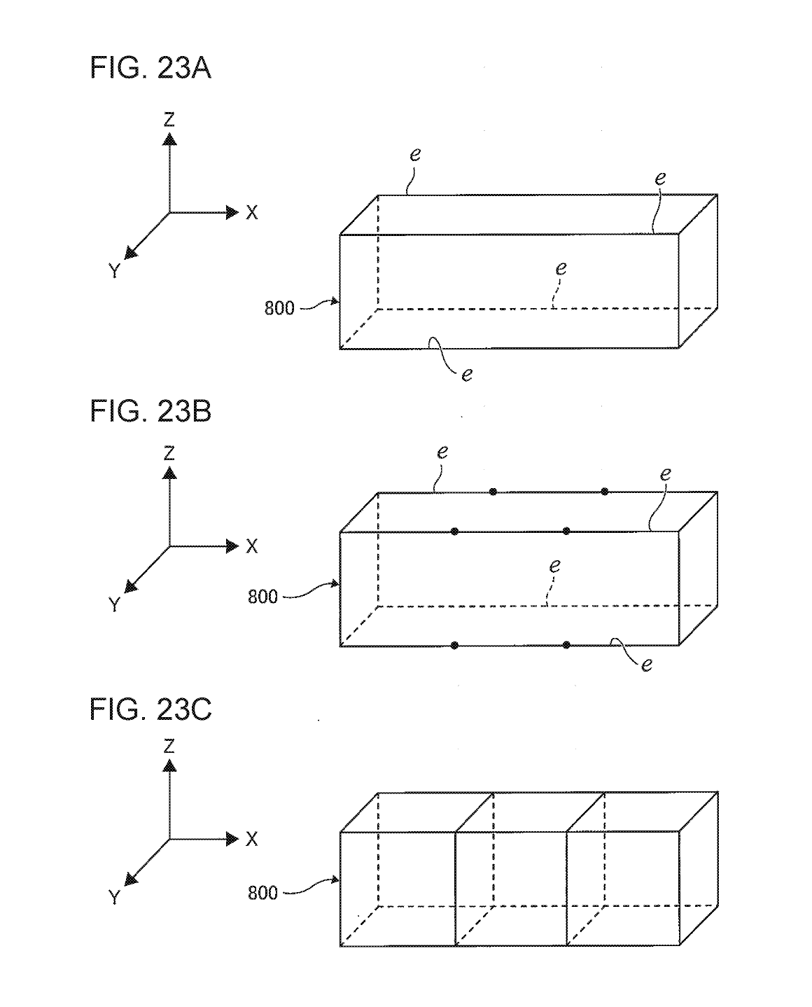

FIGS. 23A, 23B, and 23C illustrate a process for the resolution change section 114 to change the respective resolutions in the X-axis direction, the Y-axis direction, and the Z-axis direction to different values, using as an example a case where the resolution in the X-axis direction is made three times the resolution in the Y-axis direction and the resolution in the Z-axis direction. In this example, the ridge lines e of the shape 800 prescribed by the three-dimensional data received by the three-dimensional data receiving section 110 illustrated in FIG. 23A are divided into three in the X-axis direction by the resolution change section 114 as illustrated in FIG. 23B. Then, as illustrated in FIG. 23C, the resolution change section 114 connects points generated by the division to generate new polygons.

Next, a three-dimensional shaping device 500 according to a second exemplary embodiment of the present invention will be described. In the first exemplary embodiment discussed earlier, the three-dimensional shaping device 500 constitutes the three-dimensional shaping system 10 together with the data generation device 100, and shapes the shaped object 900 on the basis of the three-dimensional data generated by the data generation device 100.

In the second exemplary embodiment, in contrast, the three-dimensional shaping device 500 generates three-dimensional data, and further shapes a shaped object 900.

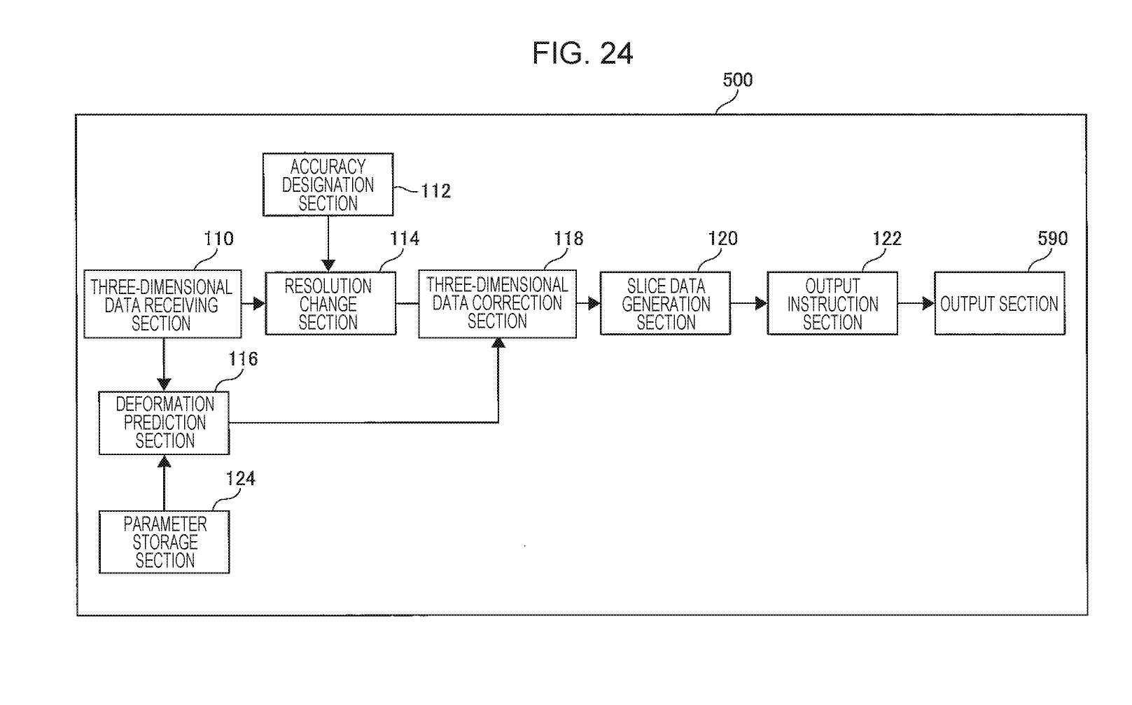

FIG. 24 is a block diagram illustrating the functional configuration of the three-dimensional shaping device 500. In the second exemplary embodiment, as illustrated in FIG. 24, the three-dimensional shaping device 500 includes the three-dimensional data receiving section 110, the accuracy designation section 112, the resolution change section 114, the deformation prediction section 116, the three-dimensional data correction section 118, the slice data generation section 120, the output instruction section 122, and the parameter storage section 124, which are components of the data generation device 100 in the first exemplary embodiment.

The three-dimensional shaping device 500 also includes an output section 590. The output section 590 outputs the shaped object 900 in response to an instruction received from the output instruction section 122. The output section 590 includes all the components of the three-dimensional shaping device 500 according to the first exemplary embodiment, such as the shaping stage 510 and the head portion 530, for example.

As has been described above, the present invention may be applied to a three-dimensional data generation device, a three-dimensional shaping device, and a non-transitory computer readable medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A three-dimensional data generation device comprising:
a deformation prediction section that predicts deformation of a shaped object after being shaped, from a shape prescribed by three-dimensional data, on a basis of a geometric feature of the shape prescribed by the three-dimensional data; and
a data correction section that corrects the three-dimensional data so as to reduce the deformation of the shaped object after being shaped, from the shape prescribed by the three-dimensional data, on a basis of the predicting by the deformation prediction section.

2. The three-dimensional data generation device according to claim 1,
wherein the data correction section corrects the three-dimensional data so as to reduce the deformation of at least a vertex and a ridge line of the shaped object.

3. The three-dimensional data generation device according to claim 1,
wherein the deformation prediction section predicts the deformation of the shaped object after being shaped, from the shape prescribed by the three-dimensional data, using at least one of an acuteness degree of a ridge line prescribed by the three-dimensional data and an acuteness degree of a vertex prescribed by the three-dimensional data as the geometric feature.

4. The three-dimensional data generation device according to claim 3,
wherein the deformation prediction section calculates the acuteness degree of the ridge line of the shape prescribed by the three-dimensional data from an angle between two surfaces that share the ridge line.

5. The three-dimensional data generation device according to claim 4,
wherein the deformation prediction section calculates the acuteness degree of the vertex of the shape prescribed by the three-dimensional data as an average of acuteness degrees of a plurality of ridge lines that share the vertex.

6. The three-dimensional data generation device according to claim 3,
wherein the deformation prediction section predicts the deformation at positions other than the ridge line and the vertex of the shape prescribed by the three-dimensional data on a basis of at least one of a distance from the vertex and a distance from the ridge line.

7. The three-dimensional data generation device according to claim 1, further comprising
an accuracy designation section that designates an accuracy of the three-dimensional data, and
a resolution change section that changes a resolution of the three-dimensional data on a basis of the accuracy designated by the accuracy designation section.

8. The three-dimensional data generation device according to claim 7,
wherein the resolution change section individually changes respective resolutions of the three-dimensional data in directions of three axes of a shaping device that shapes the shaped object, in accordance with respective accuracies of the shaping device in the directions of the three axes, the three axes crossing each other.

9. A three-dimensional shaping device comprising:
a deformation prediction section that predicts deformation of a shaped object after being shaped, from a shape prescribed by three-dimensional data, on a basis of a geometric feature of the shape prescribed by the three-dimensional data; and
a data correction section that corrects the three-dimensional data so as to reduce the deformation of the shaped object after being shaped, from the shape prescribed by the three-dimensional data, on a basis of the predicting by the deformation prediction section; and
an output section that outputs the shaped object using the three-dimensional data corrected by the data correction section.

10. A non-transitory computer readable medium storing a program causing a computer to execute a process comprising:
predicting deformation of a shaped object after being shaped, from a shape prescribed by three-dimensional data, on a basis of a geometric feature of the shape prescribed by the three-dimensional data; and
correcting the three-dimensional data so as to reduce the deformation of the shaped object after being shaped, from the shape prescribed by the three-dimensional data, on a basis of the predicting.
